(19) United States
(12) Patent Application Publication
(10) Pub. No.: US 2008/0277365 A1
(43) Pub. Date: Nov. 13, 2008

(54) Crane with 360 Degree Rotation and 3D Movement Capabilities for Fast Asset Management and Tracking

(75) Inventor: YILDIRAY SAGER, SOMERVILLE, MA (US)

Correspondence Address: YILDIRAY SAGER, 12 STANFORD TERRACE, FL.2, SOMERVILLE, MA, 02143, US

(73) Assignee: YILDIRAY SAGER, SOMERVILLE, MA (US)

(21) Appl. No.: 12/118,843

(22) Filed: May 12, 2008

Related U.S. Application Data
(60) Provisional application No. 60/917,654, filed on May 12, 2007.

(51) Int. Cl. B66C 13/00

(52) U.S. Cl. 212/285

(57) ABSTRACT

Typically, in supply-chain management systems, loading and unloading operations into and out of trailers are performed via forklifts, ramps, and elevating platforms. According to the current invention, cranes are designed in a particular way to be embeddable within trailers. Advantages comprises faster and automated loading and unloading operations, asset identification and localization for better bookkeeping and asset management and operational efficiency, and displacement and reordering of assets within mobile containers to prepare for rapid unloading

### FIELD OF THE INVENTION

This invention relates to supply-chain management systems in general, and to a crane system that accelerates loading and unloading from trailers and also that is used for asset management, tracking, and relocation in warehouses and open areas.

### SUMMARY OF THE INVENTION

Typically, in supply-chain management systems, loading and unloading operations into and out of trailers are performed via forklifts, ramps, and elevating platforms. According to the current invention, a novel design enables special cranes that are embeddable within trailers. Advantages are threefold:

Faster and automated loading and unloading operations

Asset identification and localization for better bookkeeping and asset management and operational efficiency

Displacement and reordering of assets within mobile trailers to prepare for rapid unloading

According to the invention the crane apparatus is embeddable into trailers. It is capable of rotating 360-degree on the azimuth plane and moving its hook in three dimensions.

### BRIEF DESCRIPTION OF THE DRAWINGS

FIG. 1 illustrates the building blocks of the crane 100 according to the invention

FIG. 2 provides a top view of the capable rotations and 2-axis movements of the hook 131 of the crane 100 according to the invention.

FIG. 3 illustrates the vertical movement 301 capabilities of the hook 131 of the crane 100 according to the invention.

FIG. 4 illustrates the movement of the crane 100 along the longer axis 300 of the trailer 160 according to the invention

FIG. 5 illustrates the circular base rail 520 and the electric motors 500 that enable rotations of the hook 131 on the azimuth plane according to the invention.

FIG. 6 shows the enabling mechanisms on the circular base rail 520 for movements of the hook 131 according to the invention

FIG. 7 illustrates the components that enable movement of the crane 100 along the axis of the trailer 160, which contains the crane according to the invention.

FIG. 8 denotes an example for unloading of an asset box 800 from a trailer160 with the crane 100 according to the invention.

FIG. 9 illustrates the RF and visual locator unit 910 on the crane 100 that is used to locate assets for asset tracking and management.

### DETAILED DESCRIPTION OF THE PREFERRED EMBODIMENT

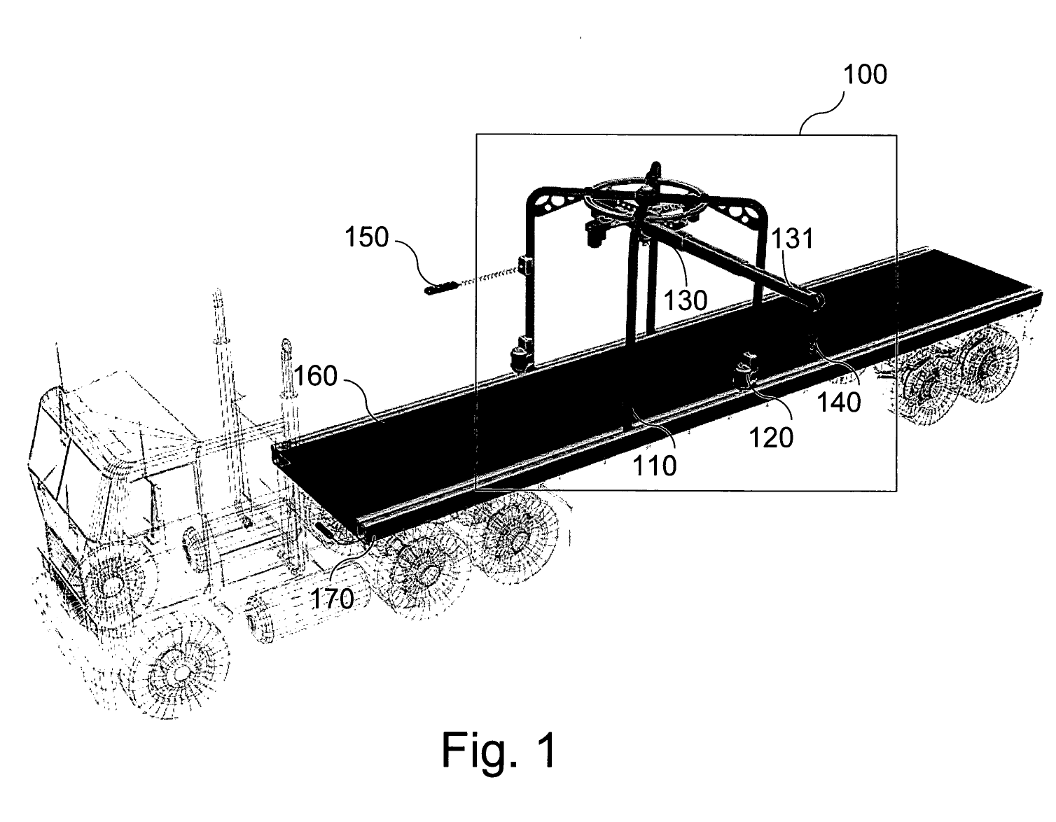

In one embodiment of the invention, the crane 100 is embeddable into a trailer 160 as illustrated in FIG. 1.The trailer 160 consists of a rail 170 on both its right and left sides throughout its length. The crane 100 consists of the following components: a remote control 150, legs 110, a hook 140, gearbox with an electric motor 120 on at least two legs 110, a telescopic boom 131. The telescopic boom 131 consists of multiple segments 130.

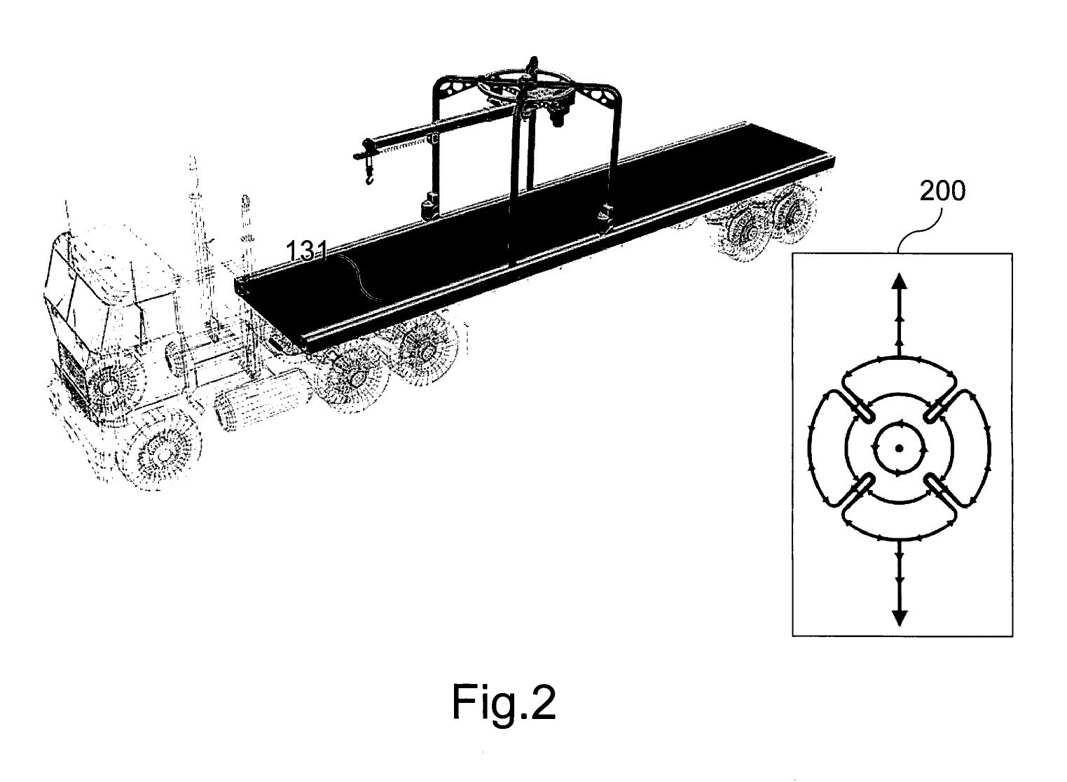

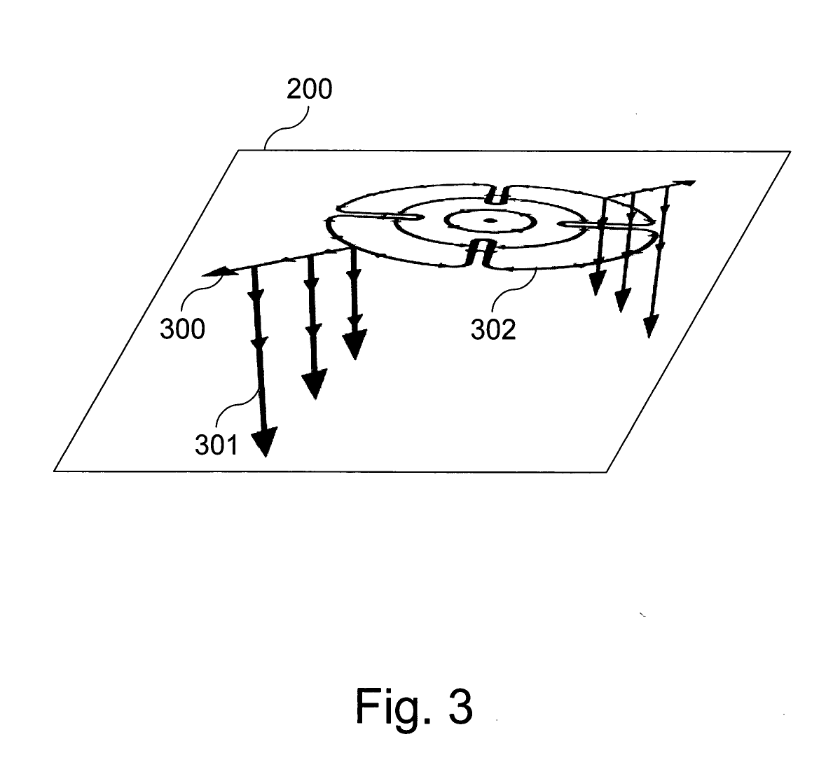

FIG. 2 and FIG. 3 denote possible movement patterns 200 of the hook 140. The hook 140 is capable of vertical movements 301, horizontal movements 300, and circular 302 movements. Therefore, the hook 140 can be positioned at any spherical coordinate around the center of the telescopic boom 131. The maximum length of the telescopic boom 131 when it 131 is extended limits the maximum radius of the movement of the hook 140.

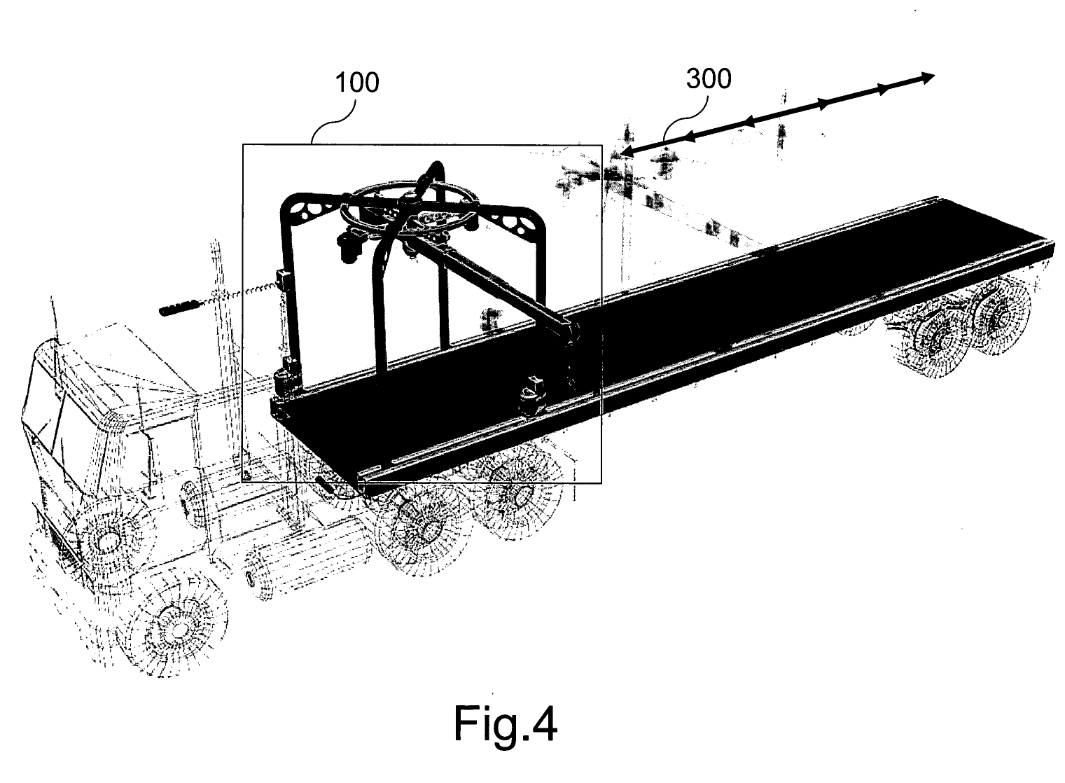

The crane 100 is capable of moving from one end of the trailer 160 to the next. This is illustrated in FIG. 4.

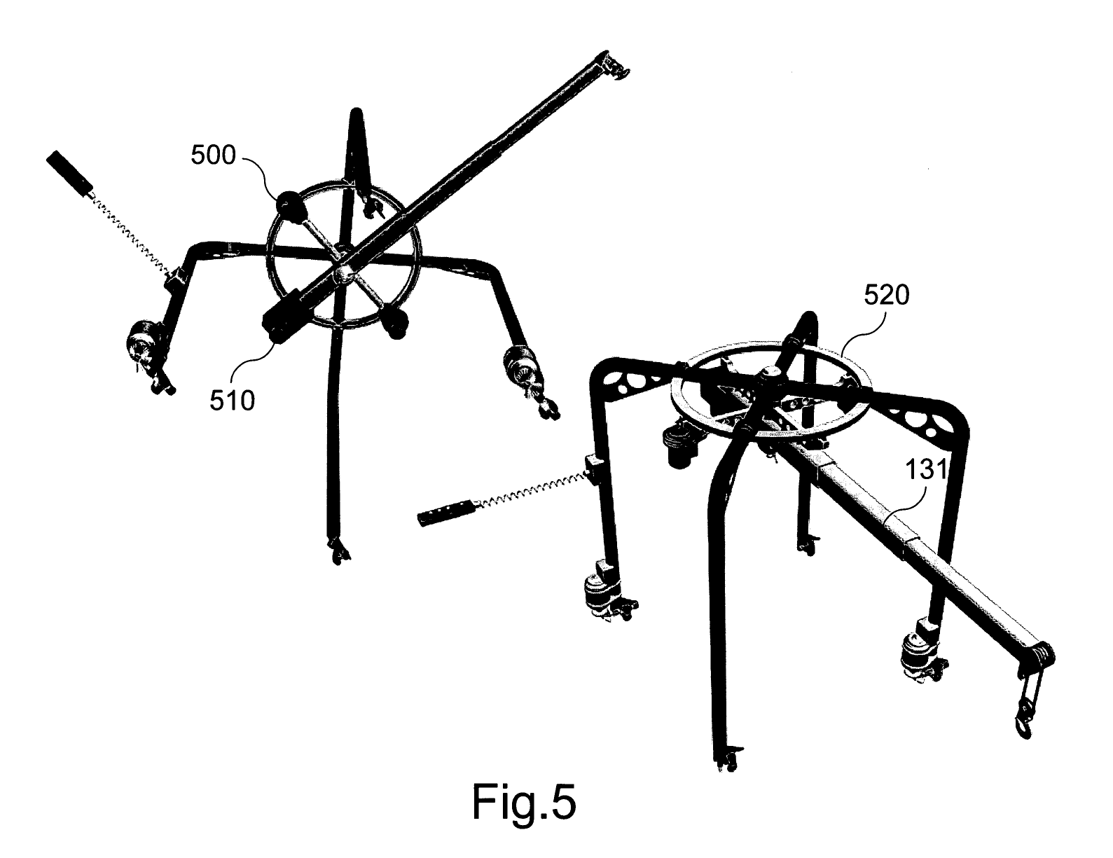

As shown in FIG. 5, the essential components that enable circular movements of the hook 140 is a circular base rail 520, the telescopic boom 131, electric motors 500 to drive circular movements and electrically powered hydraulic compressor 510 that controls how much to extend the boom 131.

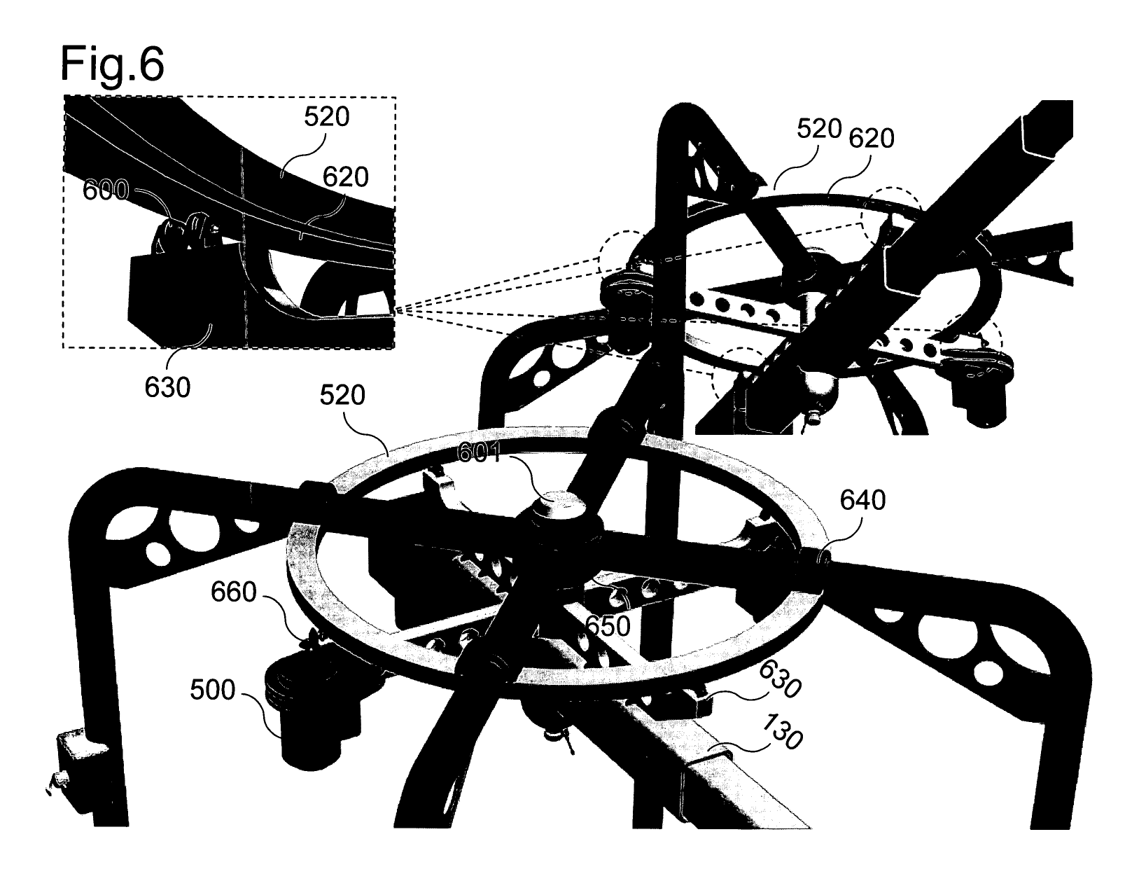

FIG. 6 denotes the enabling mechanisms for circular movements of the hook 140 in detail. The length of the base piece 130 of the boom 131 determines the shortest radius of the circular movements centered at vertical beam 601 of the telescopic boom 131. The circular rail 520 is attached to each leg 110 via mechanical joints 640. The metal house 650 that connects all the legs at the center of the circular rail 520 also holds the vertical beam 601 of the telescopic boom 131. Wheels sit on the supporting beams 630 for the centerpiece 601 of the telescopic boom 131 600 are used to enable circular movement of the telescopic boom 131 around the circular rail 520. Wheels 600 click onto the inner rail 620, which is V shaped.

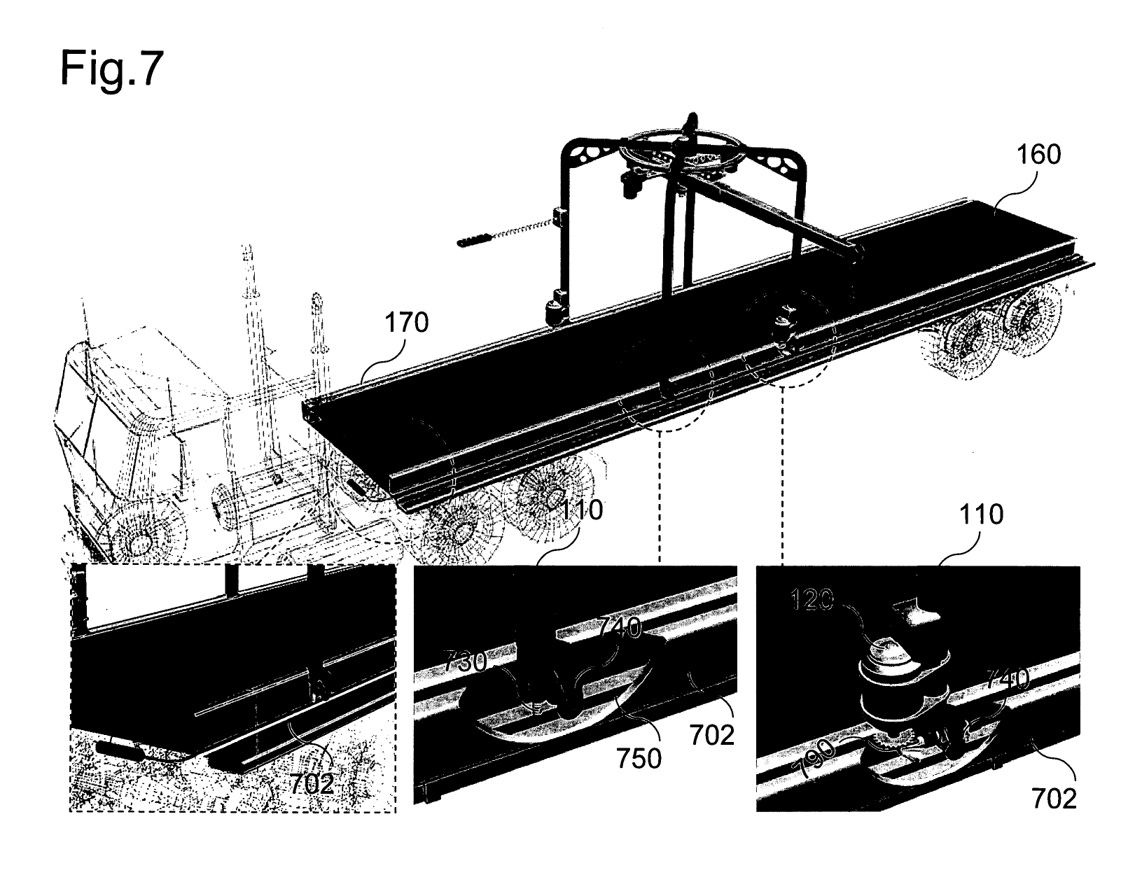

As shown in FIG. 7, the rail 170 on each side of the trailer 160 consists of a left piece 701 and right piece 702. A current conductor stripe 750 travels between these two pieces 701 and 702. It 750 provides electricity to the electrically driven crane components. Outside the rail 170, the stripe is shielded with an insulator 710. From inside each leg 110 a conductor spring 730 reaches out onto the current conductor stripe 750 to carry electric current up to the crane components. The wheel 740 of each leg resides inside the rail 170. Some legs 110 also employed with a gearbox 120 that consists of a gear 790 to enable crane movements at various speeds.

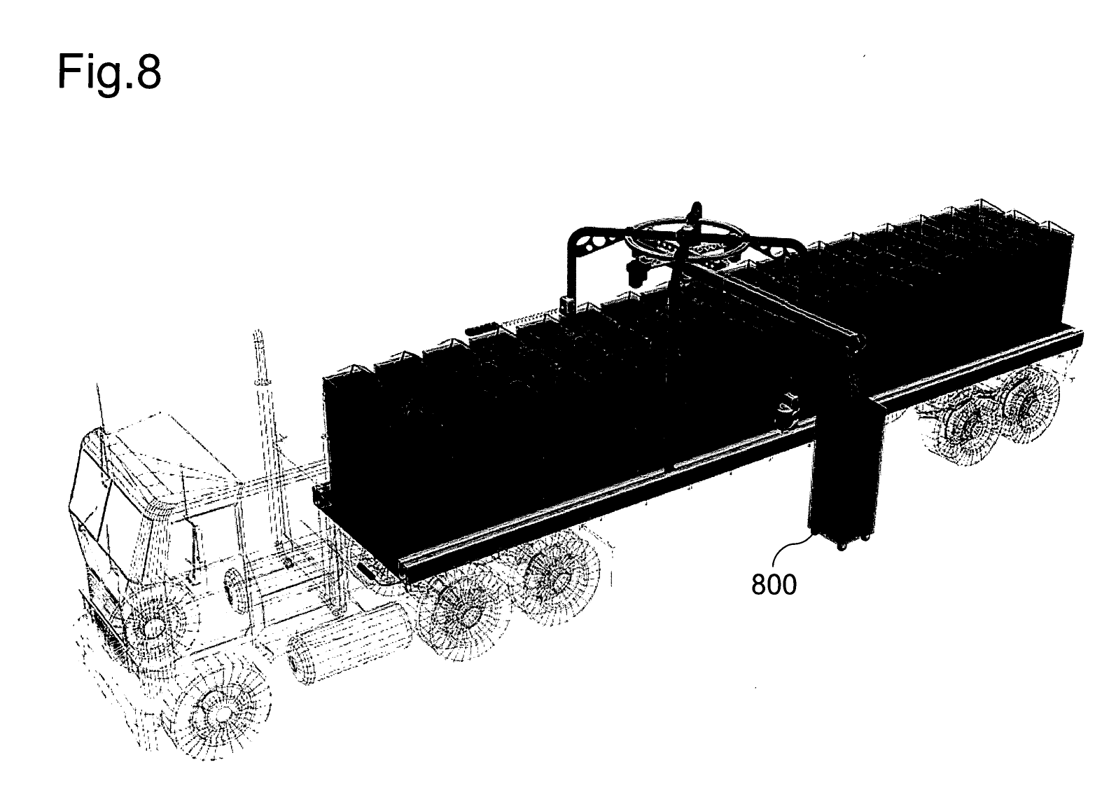

FIG. 8 exemplifies an unloading of an asset 800 from a trailer 160 by the crane 100 according to the invention.

The crane 100 is also equipped with an RF localization module 910 and image/video-processing unit 920. The RF unit 910 is used to locate assets within the container with a fine precision as long as the assets carry RF tags. The image/video processing unit is also used to locate the assets. In other words, the outputs these RF 910 and image processing 920 units are used for asset bookkeeping and tracking and localization.

Based on location information of each asset within the trailer 160, asset' 800 placement can be reorganized to ease unloading while the trailer 160 is on move towards a destination for those assets 800.

In another embodiment of the invention, it is possible to use the described crane 100 on ground services with minor modifications such as asset localization, tracking, and management, movement of an asset from a point to another in a warehouse.

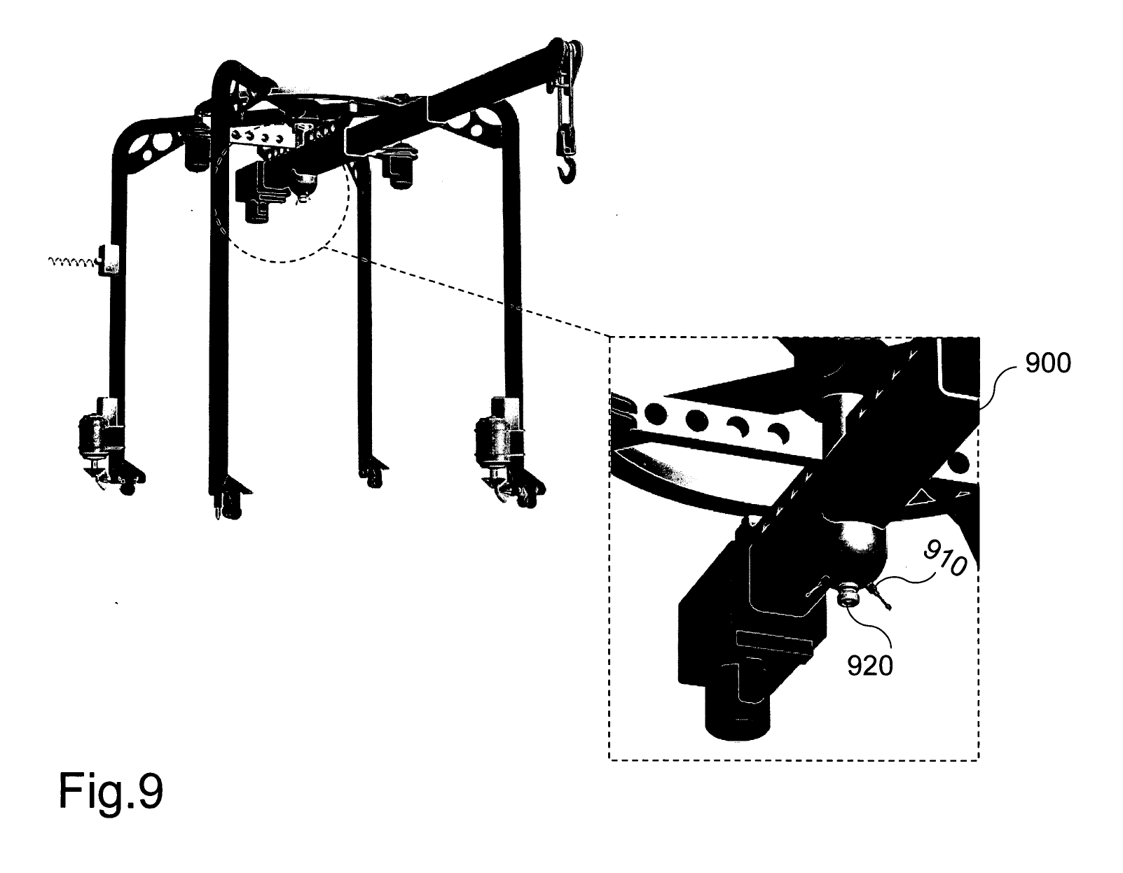

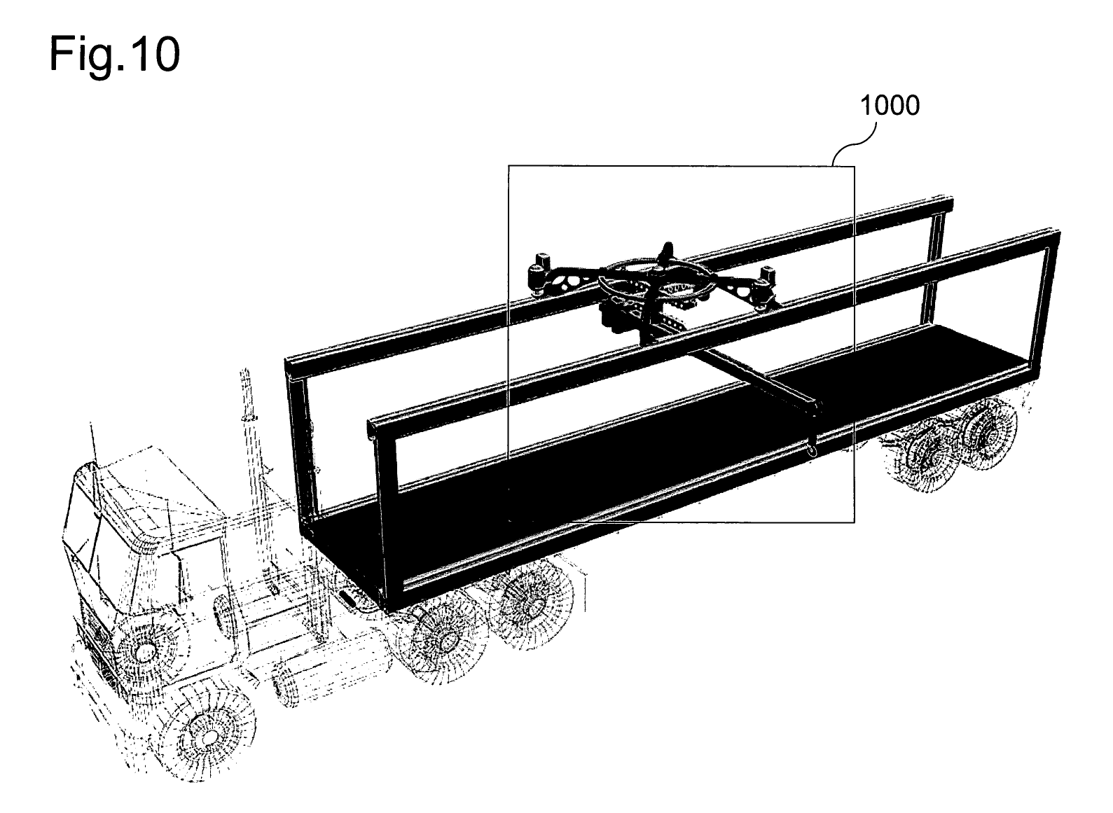

In another embodiment of the invention, it is also possible to modify the design of the crane 1000 and deploy the crane 100 on the frame of the ceiling of the trailer 160 to eliminate legs as exemplified in FIG. 9, and increase the reachable space with the hook 140.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention

What is claimed is:

1. A crane that accelerates loading to and unloading from trailers and also enables asset displacement, reordering and tracking within trailers and warehouses, comprising
An RF localization unit, an image and video processing unit, a hook, a magnetic lifter, gearbox with electric motor, a telescopic boom, remote control unit, and wheels,
wherein the said crane is capable of
a) moving via its said wheels on a platform
b) detecting and locating assets via its said RF localization module
c) detecting and locating assets via its said image/video processing unit
d) lifting the said detected and located assets via its said hook
e) lifting the said detected and located assets via its said magnetic lifter
f) carrying the said lifted assets to a different location within its reachable distance
g) loading the said lifted asset into the said platform
h) unloading the said lifted asset out of the said platform

2. The crane of claim 1, wherein the said platform comprises rails on the floor of a trailer

3. The crane of claim 1, wherein the said platform comprises rails on the ceiling of a trailer

4. The crane of claim 1, wherein the said platform comprises the floor of a warehouse

5. The crane of claim 1, the said RF localization system comprises multiple radio transceivers

6. The crane of claim 1, the said RF localization system comprises multiple infrared transceivers

7. The crane of claim 1, the said hook further comprises a circular base rail, a metal house, the said telescopic boom, motors to drive circular movements and hydraulic compressor that controls how much to extend the said telescopic boom.

8. The crane of claim 1, the said hook is capable of vertical movements, horizontal movements and circular movements. Thus, the said hook can be positioned at any spherical coordinate around the center of the said telescopic boom.

9. The hook of claim 7, the said circular base rail is attached to each said wheels in claim 1 via mechanical joints

10. The hook of claim 7, the said telescopic boom comprises vertical beams, and a centerpiece with supporting beams

11. The hook of claim 7, the said metal house holds the said vertical beams in claim 10.

12. The hook of claim 7, the said telescopic boom can make circular movements around the said circular base rail.
